(19) United States
(12) Patent Application Publication
(10) Pub. No.: US 2016/0063199 A1
(43) Pub. Date: Mar. 3, 2016

(54) Methods and Systems that Manage Spending on Implantable Health Care Devices

(71) Applicant: PA & ASSOCIATES HEALTHCARE, LLC., Baltimore, MD (US)

(72) Inventor: Richard PALAREA, Baltimore, MD (US)

(73) Assignee: PA & ASSOCIATES HEALTHCARE, LLC., Baltimore, MD (US)

(21) Appl. No.: 14/836,281

(22) Filed: Aug. 26, 2015

Related U.S. Application Data
(60) Provisional application No. 62/043,706, filed on Aug. 29, 2014.

(51) Int. Cl. G06F 19/00

(52) U.S. Cl. CPC G06F 19/328; G06F 19/324

(57) ABSTRACT

A method for the management of data for health care devices used in medical procedures includes: storing vendor profiles, including a vendor identifier, procedure types and associated procedure codes, and part identifiers and associated contract prices; receiving a billing code request, the request including a specific vendor identifier and procedure type; identifying a specific vendor profile that includes the specific vendor identifier; transmitting the procedure codes associated with the specific procedure type in the specific vendor profile; receiving a billing submission, the submission including a specific procedure code, procedure data, and specific part identifiers and associated billing prices; and determining compliance of billing prices based on a comparison, for each specific part identifier, the respective billing price to the associated contract price included in the identified specific vendor profile.

### FIELD

The present disclosure relates to the management of data for implantable health care devices used in medical procedures, specifically the management of billing submission prices for implantable health care devices with respect to agreed contract pricing between the medical institution and device vendor.

### BACKGROUND

Implantable health care devices are used on a daily basis at medical institutions across the world in order to treat a variety of symptoms. Implantable health care devices can include, for example, bone or joint replacements to assist patients with mobility, pacemakers and internal defibrillators to assist patients with heart problems, and shunts used to assist patients with the flow of bodily fluids. In many cases, vendors that manufacturer and/or distribute these devices may have deals set in place with medical institutions regarding pricing, usage, availability, etc. However, in many instances, the actual devices themselves are sold to surgeons that implant the devices on a per-use basis.

Unfortunately, the sale of the devices on a per-use basis can often be of a detriment to the medical institution. Each of the sales is submitted to the medical institution in a separate bill, with line items for each product that was used in the procedure and sold to the medical institution by the vendor. For many medical procedures, the bill submitted by the vendor may have a several different items listed. For medical institutions that perform a large number of procedures, this can lead to an overwhelming number of devices whose prices and conditions of sale must be verified. Computing systems for medical institutions lack the technology and capability to perform this kind of verification, which can often result in the medical institution losing a significant amount of money due to hidden fees, extra charges, and price overages.

Thus, there is a need for a technical solution to provide for the auditing and verification of vendor billing submissions with respect to procedures involving the use of implantable health care devices.

### SUMMARY

The present disclosure provides a description of systems and methods for the management of data for health care devices used in medical procedures.

A method for the management of data for health care devices used in medical procedures includes: storing, in a profile database of a processing server, a plurality of vendor profiles, wherein each vendor profile includes data related to a health care device vendor including at least a vendor identifier, code data, and pricing data where the code data includes a plurality of procedure types and, for each procedure type, at least one associated procedure code, and where the pricing data includes a plurality of part identifiers and, for each part identifier, an associated contract price; receiving, by a receiving device of the processing server, a data signal from a computing device comprising a billing code request, wherein the billing code request includes at least a specific vendor identifier and a specific procedure type; executing, by a querying module of the processing server, a query on the profile database to identify a specific vendor profile where the included vendor identifier corresponds to the specific vendor identifier; electronically transmitting, by a transmitting device of the processing server, a data signal to the computing device comprising the at least one procedure code associated with the specific procedure type included in the code data included in the identified specific vendor profile; receiving, by the receiving device of the processing server, a data signal from the computing device comprising a billing submission, wherein the billing submission includes data related to a medical procedure including at least a specific procedure code, procedure data, and one or more health care device data entries, where each health care device data entry includes at least a specific part identifier, a lot identifier, and a billing price; and determining, by a determination module of the processing server, compliance of billing prices to contract prices based on a comparison, for each health care device data entry included in the billing submission, the respective billing price to the contract price associated with the respective specific part identifier of the plurality of part identifier included in the identified specific vendor profile.

A system for the management of data for health care devices used in medical procedures includes a determination module, a querying module, a profile database, a receiving device, and a transmitting device of a processing server. The profile database of the processing server is configured to store a plurality of vendor profiles, wherein each vendor profile includes data related to a health care device vendor including at least a vendor identifier, code data, and pricing data where the code data includes a plurality of procedure types and, for each procedure type, at least one associated procedure code, and where the pricing data includes a plurality of part identifiers and, for each part identifier, an associated contract price. The receiving device of the processing server is configured to receive a data signal from a computing device comprising a billing code request, wherein the billing code request includes at least a specific vendor identifier and a specific procedure type. The querying module of the processing server is configured to execute a query on the profile database to identify a specific vendor profile where the included vendor identifier corresponds to the specific vendor identifier. The transmitting device of the processing server is configured to electronically transmit a data signal to the computing device comprising the at least one procedure code associated with the specific procedure type included in the code data included in the identified specific vendor profile. The receiving device of the processing server is further configured to receive a data signal from the computing device comprising a billing submission, wherein the billing submission includes data related to a medical procedure including at least a specific procedure code, procedure data, and one or more health care device data entries, where each health care device data entry includes at least a specific part identifier, a lot identifier, and a billing price. The determination module of the processing server is configured to compliance of billing prices to contract prices based on a comparison, for each health care device data entry included in the billing submission, the respective billing price to the contract price associated with the respective specific part identifier of the plurality of part identifier included in the identified specific vendor profile.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for managing data for implantable health care devices used in medical procedures in accordance with exemplary embodiments.

FIG. 2 is a block diagram illustrating the processing server of FIG. 1 for managing data for implantable health care devices used in medical procedures in accordance with exemplary embodiments.

FIG. 3 is a block diagram illustrating the profile database of FIG. 2 for the storage of vendor profiles for the management of health care device data in accordance with exemplary embodiments.

FIG. 4 is a flow diagram illustrating a process for verifying billing of an implanted health care device used in a medical procedure in accordance with exemplary embodiments.

FIG. 5 is a diagram illustrating an audited billing submission for a medical procedure involving implantable health care devices in accordance with exemplary embodiments.

FIG. 6 is a flow chart illustrating an exemplary method for the management of data for health care devices used in medical procedures in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Management of Health Care Device Data

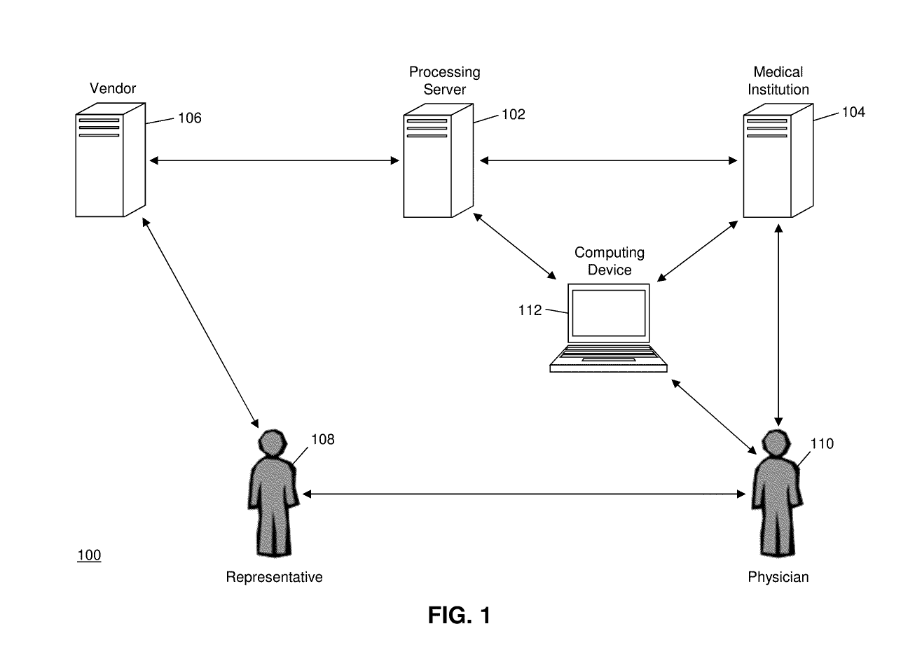

FIG. 1 illustrates a system 100 for the management of data for health care devices, including implantable health care devices, that are used in medical procedures, including the management of contract pricing and billing for use of the health care devices.

The system 100 may include a processing server 102. The processing server 102, discussed in more detail below, may be configured to manage data for health care devices used in medical procedures, including data associated with billing for the use of health care devices. Health care devices may include implantable health care devices, such as pacemakers, internal defibrillators, shunts, stents, total joints, bone screws, rods, artificial discs, pins, plates, rods, intra-uterine devices, tubes, lenses, etc., as well as any other type of health care device suitable for use in the functions disclosed herein. Health care devices may be sold to a medical institution 104 included in the system 100 for use in medical procedures for the benefit of patients. In instances where the health care device is an implantable device, a medical procedure may include the implanting of the device in the patient.

The medical institution 104 may have a contract in place with one or more vendors 106. A vendor 106 may be a manufacturer, retailer, distributor, or other entity associated with health care devices that may sell health care devices to the medical institution 104 for use in medical procedures. Contracts between the medical institution 104 and the vendor 106 may specify different procedures that may be performed using devices sold by the vendor 106, descriptions of the devices the medical institution 104 has agreed to purchase from the vendor 106, and terms for the purchase of the devices, such as pricing information. Pricing information may include a price per item, price per procedure, applicable fees, etc.

The processing server 102 may be configured to store data associated with the contract in a database, discussed more detail below. The database may be internal to the processing server 102 or external and accessed via one or more suitable communication networks, such as via cloud computing techniques. The database may also include data associated with the respective vendor 106, as well as the medical institution 104. In some embodiments, the processing server 102 may be a part of the computing systems comprising the medical institution 104. The database may be a relational database and utilizing categorization and organizational techniques associated therewith including the execution of queries on the database for identification of data stored therein.

The system 100 may include a representative 108. The representative 108 may be associated with the vendor 106 and may be authorized by the vendor 106 to sell health care devices to a physician 110 for use in medical procedures. The physician 110 may be associated with the medical institution 104 and may implant or otherwise use the health care devices sold by the representative 108 for the vendor 106 in medical procedures, as set forth in the contract established between the vendor 106 and medical institution 104. For example, the physician 110 may be restricted to specific types of health care devices they may purchase from the representative 108, which may be based on the patient, procedure, etc., the physician 110 may have to follow specific procedures or protocols for the purchase of a health care device for use in a medical procedure, etc.

The representative 108 may take a plurality of health care devices to a physician 110 that is performing a medical procedure. The representative 108 may observe the medical procedure and provide health care devices to the physician 110 during the procedure as requested by the physician 110, which may constitute the “purchase” of the health care devices. The representative 108 may keep track of what health care devices are purchased by the physician 110 during the medical procedure, and may also keep track of information regarding the medical procedure itself, such as for data storage and organizational purposes. Once the medical procedure has completed, the representative 108 or other party associated with the vendor 106 may submit a billing sheet to the medical institution 104. The billing sheet may include a listing of each of the health care devices purchased by the physician 110 as part of the medical procedure and data associated therewith, such as part identification numbers, part classification numbers, etc., information identifying the medical procedure, and a billing price for the procedure. In some instances, the billing price may include a billing price for each individual health care device purchased during the procedure.

In the system 100, the billing sheet may be submitted to the processing server 102 as a billing submission, to be verified by the processing server 102 prior to payment of the billing price by the medical institution 104. The billing sheet may be submitted to the processing server 102 by the representative 108 or physician 110, such as via a computing device 112, or directly from the computing systems of the vendor 106 or medical institution 104. For example, the representative 108 may enter the billing sheet into a computing device 112, such as a desktop computer, laptop computer, notebook computer, tablet computer, smart phone, cellular phone, smart watch, smart television, wearable computing device, etc., and the computing device 112 may electronically transmit a data signal to the processing server 102 via a suitable communication network, such as the Internet, a cellular communication network, a local area network, a radio frequency network, etc., that is superimposed with the billing sheet. In some instances, the computing device 112 and the processing server 102 may be the same device. In another example, the billing sheet may be entered into the computing systems of the vendor 106 or medical institution 104 using a suitable data entry technique, and then electronically transmitted to the processing server 102.

The processing server 102 may be configured to verify the pricing included in the billing sheet based on at least the contract data between the vendor 106 and medical institution 104. As discussed in more detail below, the processing server 102 may identify the medical procedure based on the information included in the billing sheet to identify the medical institution 104 and vendor 106 involved in the medical procedure, and then may identify the contract between the vendor 106 and medical institution 104. The processing server 102 may then compare the prices for the health care devices included in the billing sheet with prices for the health care devices included in the contract between the medical institution 104 and vendor 106. The processing server 102 may be configured to electronically transmit a notification to the medical institution 104, vendor 106, representative 108, physician 110, or other entity indicating compliance or non-compliance of the billing sheet with the contract between the vendor 106 and medical institution 104. The notification may be superimposed on a data signal electronically transmitted by the processing server 102 via a suitable communication network.

In some embodiments, the billing price may be associated with an individual health care device and may be compared to a contract price for that specific health care device. In some instances, the contract price for the specific health care device may be different based on the medical procedure in which it is used. For example, the medical institution 104 may establish procedure and/or billing codes associated with medical procedures in which health care devices may be used. The representative 108 may include a procedure code in the billing sheet that is submitted to the processing server 102, which the processing server 102 may use to identify a contract price to be compared to the billing price. In some instances, procedure codes may include both primary codes and secondary codes, such as where a primary code may be associated with a type of procedure (e.g., knee replacement) and the secondary code associated with a subset of that procedure (e.g., whole knee replacement). In such instances, a health care device may have a contract price that is specific to one or more secondary codes or a primary code.

In some embodiments, the medical institution 104 and vendor 106 may agree on a single price for an entire medical procedure. In such embodiments, one or more procedure codes may be associated with a single contract price such that the billing price of each of the health care devices in a billing sheet as a whole may be compared to the contract price for the associated medical procedure. In some instances, the contract between the medical institution 104 and vendor 106 may include a mix of pricing schemes. For example, some health care devices may have a single contract price regardless of procedure, some health care devices may have one contract price for some procedures and a different contract price for others based on procedure type, some health care devices may have a single contract price for most procedures with other procedures having a set price for all health care devices used in that procedure, etc.

The methods and systems discussed herein enable the processing server 102 to verify prices charged by a vendor 106 for health care devices used in a medical procedure, based on previously established contract prices for the health care devices as agreed upon by the vendor 106 and medical institution 104. Because the pricing schemes for various health care devices and procedures can vary greatly, and because representatives 108 provide physicians 110 with health care devices on a per-use basis at prices that can vary from transaction to transaction, the processing server 102 provides a technical solution that can verify pricing for health care devices sold to the medical institution 104 at a much higher efficiency than in traditional systems. As a result, the medical institution 104 can enforce greater compliance with contract pricing from vendors 106, resulting in a reduction in cost for medical institutions 104.

### Processing Server

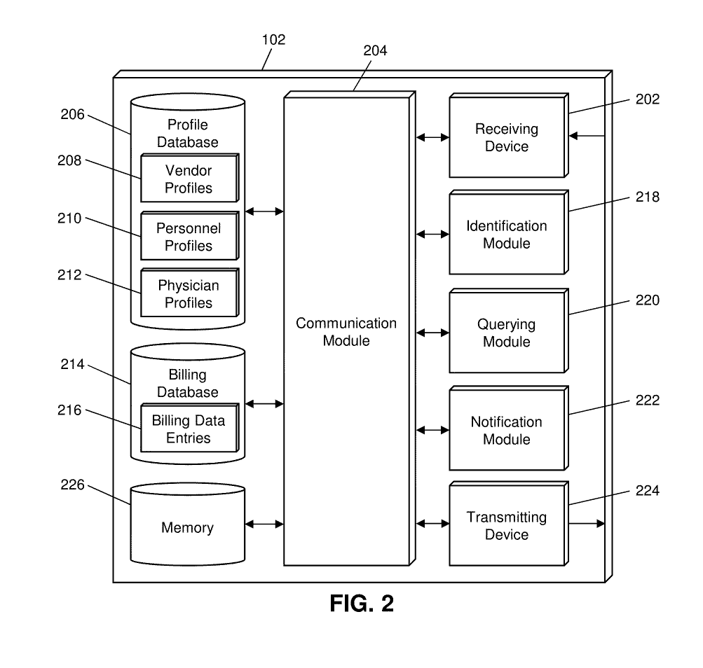

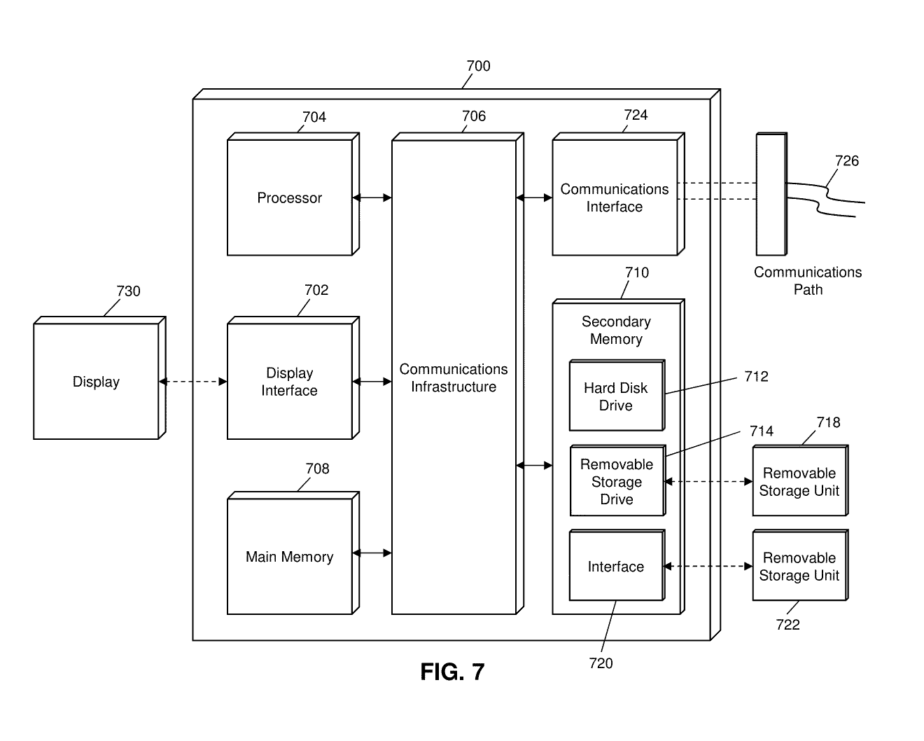

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 700 illustrated in FIG. 7 and discussed in more detail below may be a suitable configuration of the processing server 102.

The processing server 102 may include a receiving device 202. The receiving device 202 may be configured to receive data over one or more networks via one or more network protocols. In some embodiments, the receiving device 202 may be configured to receive data from medical institutions 104, vendors 106, representatives 108, physicians 110, computing devices 112, devices associated therewith, or other entities and devices using any suitable type of communication network. In some embodiments, the receiving device 202 may be comprised of multiple devices, such as different receiving devices for receiving data over different networks, such as a first receiving device for receiving data over a local area network and a second receiving device for receiving data over the Internet. The receiving device 202 may receive electronically data signals that are transmitted, where data may be superimposed on the data signal and decoded, parsed, read, or otherwise obtained via receipt of the data signal by the receiving device 202. In some instances, the receiving device 202 may include a parsing module for parsing the received data signal to obtain the data superimposed thereon.

The receiving device 202 may be configured to receive data signals electronically transmitted by the vendor 106, medical institution 104, computing device 112, or other device and/or entity that are superimposed with contract data. The contract data may include a plurality of procedure codes and/or part identifiers and associated pricing data. In some instances, contract data may also include a vendor identifier and/or a medical institution identifier suitable for identifying the vendor 106 or medical institution 104, respectively, associated with the contract. The receiving device 202 may also be configured to receive data signals superimposed with billing submissions. Billing submissions may include data related to a medical procedure that includes part identifiers for health care devices purchased as part of the medical procedure, billing prices for each health care device and/or the medical procedure, one or more procedure codes and/or procedure types associated with the medical procedure, and other procedure data, such as patient data, time, date, operating room, medical institution 104, vendor 106, representative 108, physician 110, etc.

In some embodiments, the receiving device 202 may also be configured to receive data signals superimposed with billing code requests, such as may be submitted by a computing device 112, such as by the physician 110, representative 108, or other user, such as health care personnel. Billing code requests may include one or more procedure types or codes that may be used for the identification of procedure codes for inclusion in a billing submission that may be used by a medical institution 104. In some instances, the billing code request may include an identifier associated with the medical institution 104 and/or vendor 106 for use in identification of associated procedure codes. For example, a medical institution 104 may have a defined set of procedure codes, with each vendor 106 only being eligible for specific procedure codes from the set.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc.

The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device. For example, as illustrated in FIG. 2, the processing server 102 may include an identification module 218, a querying module 220, and a notification module 222, which may comprise a processing device of the processing server 102, such as may be incorporated in one or more processors having one or more processor cores. In some instances, the modules may be implemented using a combination of hardware (e.g., of the processor) and software, which may comprise application programs having program code stored in the processing server 102 and executed by a processor. It will be apparent to persons having skill in the relevant art that the processing server 102 may include additional modules and/or engines suitable for performing the functions discussed herein, such as a parsing module for parsing data signals received by the receiving device 202 into usable data (e.g., into a module for processing such data), an encryption module for encrypting or decrypting data transmitted to and from the processing server 102, etc.

The processing server 102 may also include a profile database 206. The profile database 206, discussed in more detail below, may be configured to store a plurality of vendor profiles 210 using a suitable data storage format and schema. Each vendor profile 210, also discussed in more detail below, may be configured to store data related to a vendor 106 associated with a medical institution 104. The data stored therein may include, for example, a vendor identifier, which may be a unique value associated with the related vendor 106, such as an identification number, as well as contract data, procedure data, representative data, and any other data suitable for use in performing the functions disclosed herein. In some instances, a vendor profile 208 may include data associated with the vendor 106 and a plurality of different medical institutions 104. In other instances, the profile database 206 may include a separate vendor profile 208 for a vendor 106 and each associated medical institution 104, which may include a unique identifier associated with the medical institution 104.

In some embodiments, the profile database 206 may include additional profiles, such as a personnel profile 210 and a physician profile 212. The personnel profile 210 and physician profile 212 may each be configured to store data associated with health personnel or a physician 110, respectively, that may be associated with a vendor 106, medical institution 104, the processing server 102, or other party that may be involved in the purchasing of health care devices used in medical procedures. Health personnel may include, for example, nurses, aides, data entry specialists, insurance providers, insurance representatives, vendor representatives 108, vendor employees, etc. In such instances, the personnel profile 210 or physician profile 212 may include data associated with the respective party, such as authentication information, access information (e.g., regarding what data may be accessed, entered, edited, etc.), procedure data (e.g., related to procedures involving the party), etc. For example, a physician profile 212 may include data related to each medical procedure where the related physician 110 performed and purchased health care devices. In some embodiments, the personnel profiles 210 and/or physician profiles 212 may be stored in additional databases included in the processing server 102.

The processing server 102 may also include a billing database 214. The billing database 214 may be configured to store one or more billing data entries 216 using a suitable data storage format and schema. Each billing data entry 316 may be a structured data set configured to store data related to a billing submission received by the receiving device 202 of the processing server 102. The billing data entry 316 may include, for example, a billing sheet identifier, which may be a unique value associated with the respective billing sheet, a procedure identifier or other procedure data, such as procedure codes, part identifiers and other part data for health care devices used in the corresponding procedure, and one or more billing prices. In some cases, a billing data entry 316 may include a separate price for each health care device. In other cases, a billing data entry 316 may include a single, total price, which may be an aggregate price for each health care device, or an overall price associated with the corresponding procedure. In some instances, the billing database 214 may be combined with the profile database 206, such that billing data entries 216 may be stored in a vendor profile 208 associated with the vendor 106 and medical institution 104 involved in the corresponding medical procedure.

In some embodiments, the processing server 102 may also include additional databases configured to store data suitable for performing the functions disclosed herein. For example, the processing server 102 may include a procedure database configured to store data associated with medical procedures involving the medical institution 104 and/or vendor 106. In another example, the processing server 102 may include a contract database configured to store data associated with contracts involving medical institutions 104 and vendors 106. In such embodiments, data stored in the additional databases may not be stored in the profile database 206 or billing database 214, may be stored in multiple databases, or may be stored in one database and referenced in other databases, such as via techniques apparent to persons having skill in the relevant art associated with relational databases.

The processing server 102 may include an identification module 218. The identification module 218. The identification module 218 may be configured to identify data included in data received (e.g., and parsed) by the receiving device 202, identify from databases internal in or external to the processing server 102, etc. The identification module 218 may receive a set of data and one or more rules or instructions, may identify data from the set of data base don the rules or instructions, and may output the data. For example, when the receiving device 202 receives and parses a billing submission, the identification module 218 may be configured to identify a vendor identifier and/or medical institution identifier for use in identifying a vendor profile 208, and subsequently a contract associated therewith.

The processing server 102 may also include a querying module 220. The querying module 220 may be configured to execute queries on databases internal in or external to the processing server 102 to identify data stored therein. The querying module 220 may receive a query string or other data suitable for use in generating a query, may execute the query on a database to identify data stored therein, and may output the identified data. For instance, when a billing submission is received and vendor identifier identified by the identification module 218, the querying module 220 may execute a query on the profile database 206 to identify a vendor profile 208 that includes the vendor identifier read from the billing submission. The querying module 220 may output the vendor profile 208, such as to the identification module 218 for identification of contract data and contract prices included therein. The identification module 218 may then compare contract prices identified from the identified vendor profile 208 with billing prices identified from the received billing submission. In some embodiments, one or more databases may be a relational database, with the querying module 220 configured to execute queries thereon to identify data stored therein, including relationship data and other relational information.

The processing server 102 may further include a notification module 222. The notification module may be configured to generate data signals superimposed with notifications, such as for transmission to vendors 106, medical institutions 104, representatives 108, physicians 110, computing devices 112, etc. For instance, the notification module 222 may generate a data signal superimposed with a notification regarding a received billing submission, which may include data included therein, and may also include data based on the comparison performed by the identification module 218. For example, the notification may include billing submission data, contract data, and an indication if the billing price(s) included in the billing submission is compliant or non-compliant with the terms and/or pricing of the contract.

In some embodiments, the processing server 102 may also include a determination module. The determination module may be configured to make determinations based on data and/or rules input thereto and output the corresponding determinations. For example, in some embodiments, the determination module may be used to determine compliance or non-compliance of a billing submission with contract prices based on information identified by the identification module 218. In some instances, modules of the processing server 102 may be combined into a single module configured to perform functions of each of the combined modules and/or modules may be separate into multiple modules, which as a whole perform the functions of the initial module. In such instances, the functions of the determination module may be, for example, performed by the identification module 218 and notification module 222.

The processing server 102 may further include a transmitting device 224. The transmitting device 224 may be configured to transmit data over one or more networks via one or more network protocols. In some instances, the transmitting device 224 may be configured to transmit data to medical institutions 104, vendors 106, representatives 108, physicians 110, computing devices 112, and other entities via suitable networks, such as the Internet. In some embodiments, the transmitting device 224 may be comprised of multiple devices, such as different transmitting devices for transmitting data over different networks, such as a first transmitting device for transmitting data over a local area network and a second transmitting device for transmitting data over the Internet. The transmitting device 224 may electronically transmit data signals that have data superimposed that may be parsed by a receiving computing device. In some instances, the transmitting device 224 may include one or more modules for superimposing, encoding, or otherwise formatting data into data signals suitable for transmission.

The transmitting device 224 may be configured to electronically transmit data signals superimposed with procedure codes and types to representatives 108, computing devices 112, data entry specialists, etc. in response to billing requests for inclusion in later billing submissions. The transmitting device 224 may also electronically transmit data signals superimposed with notifications. Notifications may notify medical institutions 104, vendors 106, representatives 108, physicians 110, or other entities of received billing submissions and determinations made with respect to billing prices included therein as compared to contract prices. Notifications may be electronically transmitted to, for example, a billing department in the medical institution 104 for use in paying the vendor 106 for the purchased health care devices. Notifications may be transmitted via any suitable method, such as e-mail, short messaging service message, multimedia messaging service message, an application programming interface with external computing systems, via being made available using an internal application programming interface, etc.

The processing server 102 may also include a memory 226. The memory 226 may be configured to store data for use by the processing server 102 in performing the functions discussed herein. The memory 226 may be configured to store data using suitable data formatting methods and schema and may be any suitable type of memory, such as read-only memory, random access memory, etc. The memory 226 may include, for example, encryption keys and algorithms, communication protocols and standards, data formatting standards and protocols, program code for modules and application programs of the processing unit, and other data that may be suitable for use by the processing server 102 in the performance of the functions disclosed herein as will be apparent to persons having skill in the relevant art.

### Transaction Database

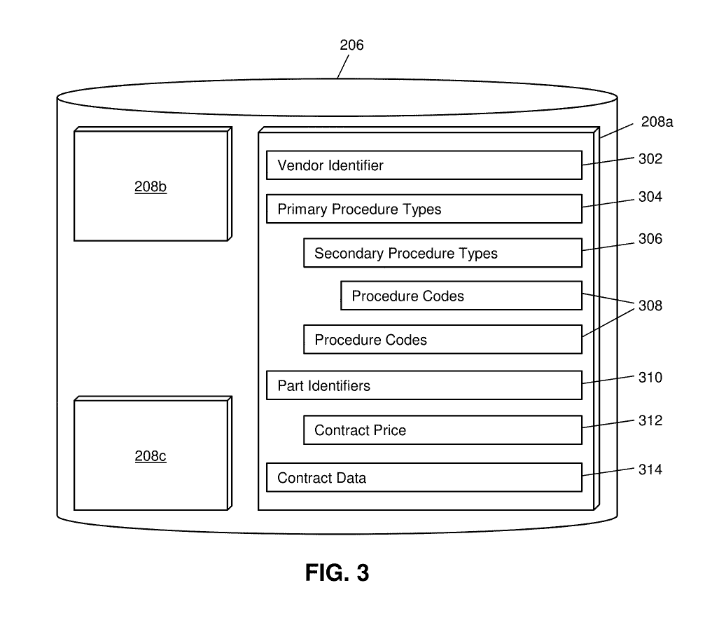

FIG. 3 illustrates the profile database 206 of the processing server 102 for the storage of data associated with the purchasing of health care devices in vendor profiles 208. The profile database 206 may store a plurality vendor profiles 208, illustrated in FIG. 3 as vendor profiles 208a, 208b, and 208c, using any suitable data storage format and schema. For example, the vendor database 206 may be a relational database that utilizes structured query language for the storage, identification, modifying, updating, accessing, etc. of structured data sets stored therein.

Each vendor profile 208 may include a vendor identifier 302. The vendor identifier 302 may be a unique value associated with the vendor 106 related to the vendor profile 208 suitable for the identification thereof, such as an identification number, device identifier associated with a computing system or device of the vendor 106, etc. In some embodiments, a vendor profile 208 may also include an identifier associated with a medical institution 104, such as in instances where each vendor profile 208 may be unique to a combination of vendor 106 and medical institution 104.

Each vendor profile 208 may further include one or more primary procedure types 304. Each primary procedure type 304 may be a type of medical procedure that the vendor 106 is authorized by the medical institution 104 (e.g., associated with the specific vendor profile 208 or processing server 102) to sell health care devices for. Each procedure type may include a plurality of procedure codes 308. Each procedure code 308 may be a numerical or other type of code that is indicative of a medical procedure, which may be a subset of the corresponding primary procedure type 304. For example, if a primary procedure type 304 is a knee replacement, a procedure code 308 may be a whole knee replacement. In some instances, a primary procedure type 304 may include one or more secondary procedure types 306, with each secondary procedure type 306 having one or more procedure codes 308. For example, the primary procedure type 304 may be a stent implantation, the secondary procedure type 306 may be a coronary stent implantation, and the procedure code 308 may correspond to a bare-metal stent implantation in the coronary artery.

A vendor profile 308 may also include a plurality of part identifiers 310. Each part identifier 310 may be a unique value associated with a health care device that may be sold or otherwise distributed to the medical institution 104 (e.g., or a physician 110 associated therewith) by the related vendor 106 for use in a medical procedure. The part identifier 310 may be an identification number or other representation that may be used by the vendor 106 and/or medical institution 104 that is unique to the related health care device. In some instances, the part identifier 310 may be unique to the type of device, but not each individual device (e.g., each artificial knee may include a common part identifier). In such instances, a further identifier (e.g., a serial number, lot number, etc.) may be used to reference individual devices.

Each part identifier 310 may be associated with a contract price 312. The contract price 312 may be a price associated with the part identifier 310 that is agreed upon by the vendor 106 and medical institution 104 for the cost of the respective health care device. In some instances, a part identifier 310 may be associated with a plurality of contract prices 312, such as instances where a contract price 312 may be specific to the type of procedure in which the health care device is used. In such an instance, a contract price 312 may be associated with a part identifier 310 and a procedure code 308 and/or primary procedure type 304. In some embodiments, the contract price 312 associated with a part identifier 310 may be a price for all health care devices associated with a specific procedure. In such embodiments, the contract price 312 may be associated with an indicator that indicates the price as such, or the contract price 312 may be a zero or other nominal value, with additional data included in the vendor profile 208 indicating the procedure pricing.

Each vendor profile 208 may also include contract data 314. The contract data 314 may be data associated with the contract between the related vendor 106 and the associated medical institution 104. The contract data 314 may include, for example, one or more contract terms, start date, expiration date, representative data, physician data, a data file comprising the full contract, etc. In some instances, the contract data 314 may also include business rules, algorithms, and/or triggers, which may be used in the verification of billing submissions. The business rules, algorithms, and/or triggers may be entered in as part of the contract data 314 (e.g., by a user of the medical institution 104) or may be generated based on contract terms and conditions entered into the contract data 314. For example, the contract may include a term that a specific representative 108 may only sell health care devices to a specific subset of physicians 110 of the medical institution 104. In such an example, one or more business rules may be generated by the processing device 102 (e.g., and stored in the contract data 314 or elsewhere in the vendor profile 208) to check for verification of the relationship between the physician 110 and representative 108 when verifying billing submissions. For instance, in addition to checking the billing price of health care devices in a billing submission, the processing server 102 may also check to ensure the representative 108 associated therewith is authorized to sell health care devices to the physician 110 associated with the medical procedure. Such additional verifications may also be reflected in notifications, reporting, and other auditing performed by and/or for the medical institution 104.

In some embodiments, the processing server 102 may be configured to modify business rules, algorithms, and/or triggers based on modifications to the contract data 314. For example, if one or more terms and conditions for the contract are modified by the vendor 106 and/or medical institution 104, then the processing server 102 may modify associated business rules, algorithms, and/or triggers associated therewith. For instance, in the example where representative-physician relationships are part of the contract terms, the terms of the contract may be modified to change the relationships, such as if a new representative 108 is hired. In such an instance, the processing server 102 may modify the business rules associated with representative-physician relationships such that the updated relationships are considered when performing verification of billing submission data.

In some embodiments, a vendor profile 208 may also include additional data suitable for performing the functions disclosed herein. For example, the vendor profile 208 may include data related to a representative 108, physician 110, or other health care personnel, such as contact information, authentication information, data entry permissions, etc. The vendor profile 208 may also include notification information, which may indicate one or more parties that may be notified (e.g., and contact information and a method of contact for notification thereof) as well as conditions for notification, such as to notify vendors 106 upon incorrect pricing, notify the medical institution 104 upon a new bill being submitted and verified, notify a particular employee of the medical institution 104 if the overall billed price for a submission is above a predetermined value above the contract price, etc.

### Process for Verifying Health Care Device Billing Data

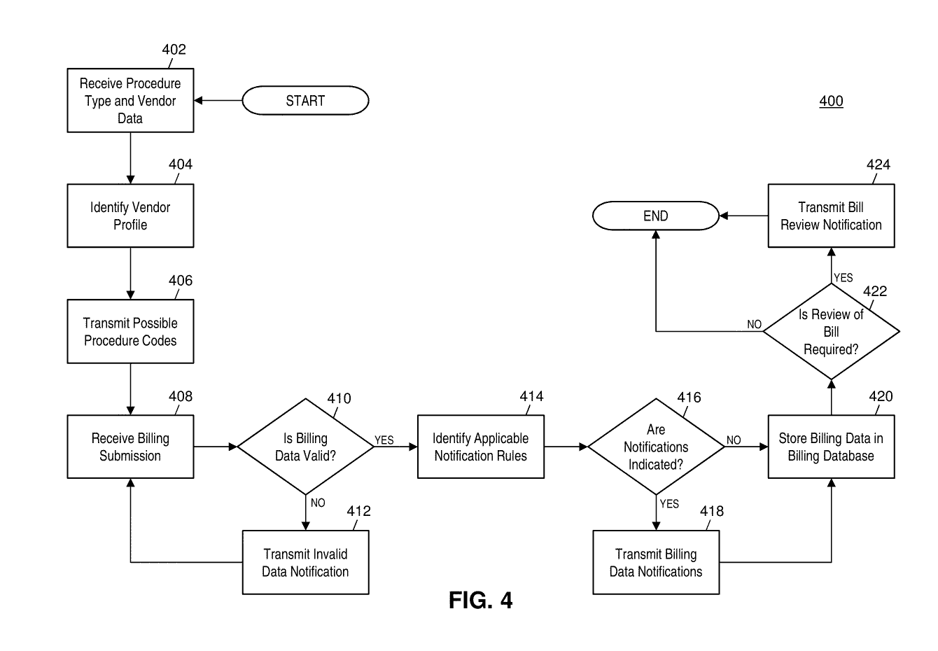

FIG. 4 illustrates a process 400 for the verification of data with regard to a billing submission for one or more health care devices purchased for use in a medical procedure.

In step 402, the receiving device 202 of the processing server 102 may receive a data signal electronically transmitted from a computing device 112 or other computing system using a suitable communication network. The data signal may originate from the representative 108, physician 110, or other data entry personnel and may be superimposed with a billing code request, the billing code request including at least a vendor identifier 302 and a procedure type 304. In step 404, the querying module 220 of the processing server 102 may execute a query on the profile database 206 to identify a vendor profile 208 that includes the vendor identifier 302 parsed from the billing code request.

In step 406, the identification module 218 of the processing server 102 may identify one or more procedure codes 308 associated with the procedure type 304 parsed from the received billing code request, and the transmitting device 224 of the processing server 102 may electronically transmit a data signal to the computing device 112 or other computing system that is superimposed with the identified procedure codes 308. The user of the computing device 112 (e.g., the representative 108, physician 110, data entry specialist, or other personnel) may receive the procedure codes 308 and may select one corresponding to the medical procedure for which health care devices were purchased. The procedure code 308 may then be included in a billing submission that is submitted to the processing server 102 and received by the receiving device 202, in step 408.

The billing submission may be electronically transmitted in a data signal via a suitable communication network, such as the Internet, and may include the specific procedure code 308, procedure data associated with the related medical procedure, one or more part identifiers 310 corresponding to health care devices purchased in the associated medical procedure, and a billing price for each of the health care devices. In instances where a single price may be charged for the medical procedure, the billing price for each health care device may be zero, or the billing submission may include a billing price for each health care device with a total price indicated for the single price being charged.

In step 410, the processing server 102 may determine if the data included in the billing submission is valid. The determination may be made by the identification module 218 or other module of the processing server 102, and may be based on the data included in the billing submission as compared to data included in the vendor profile 106 associated with the involved vendor 106 (e.g., as identified from the profile database 206 by the querying module 220), such as the procedure codes 308, part identifiers 310, and contract data 314. For example, the billing submission may be invalid if a part identifier 310 included in the billing submission is in an improper format or not accepted by the medical institution 104, if the billing submission is missing required procedure data, if billing submission includes an invalid procedure code 308, etc. If the billing submission is determined to be invalid, then, in step 412, the notification module 222 of the processing server 102 may generate a data signal that is superimposed with a notification that indicates that the billing submission is valid, which may indicate the reason for the invalidity, and the transmitting device 224 of the processing server 102 may electronically transmit the notification to the computing device 112 that submitted the billing submission.

If the billing submission is determined to be valid, then, in step 414, the identification module 218 may identify one or more notification rules that may be stored in the vendor profile 208 related to the vendor 106 involved in the sale of the health care devices for the medical procedure that may be applicable to the billing submission. The identification may also be based on the identification of the identification module 218 in determining compliance with the contract prices by the billing submission. The determination may be based on the billing prices included in the billing submission with the contract prices 312 associated with the part identifiers 310 that are included in the identified vendor profile 208. The identification module 218 may then identify if any notification rules apply to the billing submission based thereon, such as notification rules regarding the type of medical procedure (e.g., indicated by the specific procedure code 308 or other procedure data), compliance with the contract prices, etc. In step 416, the identification module 218, notification module 222, or other module may determine if the notification rules indicate that one or more notifications are to be transmitted based on the billing submission. For example, applicable notification rules may be applied to the billing submission or data associated therewith, but may indicate that no notification is to be transmitted, such as if the billing price for a health care device is non-compliant with a contract price, but is found to be below the contract price.

If one or more notifications are to be transmitted, then, in step 418, the notification module 222 may generate data signals superimposed with the notifications, which may then be electronically transmitted by the transmitting device 224 to the appropriate entity, such as specified in the corresponding notification rule and using a specified communication method. Once notifications are transmitted, or if no notifications were indicated, then, in step 420, the querying module 220 of the processing server 102 may execute a query on the billing database 214 to generate a new billing data entry 216 corresponding to the billing submission. The billing data entry 216 may include each of the data values included in and parsed from the received billing submission, and may also include additional data, such as the notifications, indications of compliance or non-compliance with the contract prices 312, etc.

In step 422, the notification module 222 may determine if review of the billing submission is required by the medical institution 104. The determination may be made based on review or notification rules stored in the identified vendor profile 208. For example, the medical institution 104 may set a rule specifying that all billing submissions must be reviewed, that only billing submissions with non-compliant billing prices must be reviewed, that different types of billing submissions (e.g., based on procedure type 304, procedure code 308, contract compliance, etc.) may have different classifications for review (e.g., scrutiny levels, reviewing personnel, etc.), etc. If review is not required, then the process 400 may be completed. If review is required, then, in step 424, the notification module 222 may generate a data signal superimposed with a notification to be electronically transmitted by the transmitting device 224 to the medical institution 104 as set forth in the corresponding rules.

In some embodiments, the processing server 102 may be further configured to generate reports for electronic transmission to the medical institution 104 or other entity, such as a part of the notification of data to the medical institution 104. For instance, once a billing submission has been added to the billing database 214 as a billing data entry 216, a module of the processing server 102 may update one or more reports regarding the vendor 106, the representative 108, physician 110, type of procedure, type of health care device used, etc. For example, the processing server 102 may generate reports regarding the vendor's or representative's compliance with contract prices, a physician's acceptance of non-contract prices, a physician's selection of one vendor 106 or representative 108 over another, and other metrics that may be suitable for use by the medical institution 104 or other entity based on the data discussed herein.

### Verification of Contract Compliance for Health Care Devices

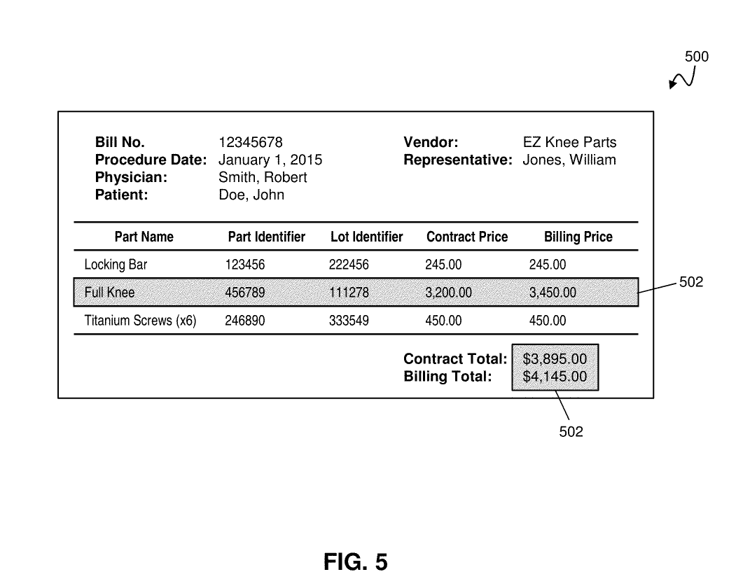

FIG. 5 illustrates a billing submission notification 500 that may be generated by the notification module 222 of the processing server 102 for electronic transmission to the medical institution 104 by the transmitting device 224 of the processing server 102. It will be apparent to persons having skill in the relevant art that the billing submission notification 500 illustrated in FIG. 5 and discussed herein may be provided as an illustration only and that alternative notifications may be generated by the notification module 222 that include additional and/or alternative data and illustrations thereof for use in conjunction with the methods and systems discussed herein.

As illustrated in FIG. 5, the billing submission notification 500 may include procedure data associated with the medical procedure to which the billing submission notification 500 corresponds. In the illustrated example, the procedure data includes a billing number, a procedure data, a name of the physician 110, a name of the patient, a name of the vendor 106 that provided the health care devices, and a name of the representative 108 of the vendor 106.

The billing submission notification 500 may also include a list of health care devices that were sold to the physician 110 for use in the corresponding medical procedure. As illustrated in FIG. 5, each health care device may include a part name, a part identifier (e.g., corresponding to the part identifier 310 in the vendor profile 208 associated with the vendor 106), a lot identifier, a contract price (e.g., corresponding to the contract price 312 associated with the part identifier 310), and a billing price.

In instances where a billing submission may be non-compliant, the billing submission notification 500 may include indications 502. Each indication 502 may indicate a data value of the billing submission that is non-compliant as determined by the processing server 102. In the example illustrated in FIG. 5, indications 502 are included in the billing submission notification 500 to indicate that the billed price for the Full Knee is greater than the contract price for the health care device, and that the overall price that is billed is greater than the price that should be charged based on the contract. For instance, the billing submission notification 500 may be electronically transmitted to a computing device 112 of the medical institution 104, which may display the billing submission notification 500 to a user, such as an employee of the medical institution 104, for review.

In some instances, evaluation for contract compliance of a billing submission with contract data may include additional validations and verifications that may be performed in addition to verification of billing pricing against contract pricing. For example, the contract data 314 may include additional data that may comprise or may be used to identify (e.g., via one or more of the modules or engines of the processing server 102) business rules, algorithms, and/or triggers for use in the determination of compliance therewith. For example, the contract between the medical institution 104 and the vendor 106 may stipulate various combinations of health care devices that are eligible and/or ineligible for use in a medical procedure. In such an example, a business rule may be established that may be verified by the identification module 218 or other suitable module of the processing server 102 when a billing submission is verified, such as by checking each of the health care devices included in the billing submission against the business rule of eligible/ineligible combinations. In such an instance, the billing submission notification 500 may include an indication of the results of the verification of the business rule. The processing server 102 may be configured to perform the verification and reporting for a plurality of different business rules, algorithms, and triggers based on the contract data 314.

In some instances, the billing rules, algorithms, and/or triggers may be entered as part of the contract data 314, such as by a user of the medical institution 104 using the computing device 112. In other instances, the processing server 102 may (e.g., via the identification module 218 or other suitable module) generate business rules, algorithms, and/or triggers from entered contract data 314, such as using rules and/or algorithms specially configured for the generation thereof. In such instances, the processing server 102 may be configured to modify business rules, algorithms, and/or triggers if the associated terms and conditions of the contract data 314 are modified, such that the verification is performed accurately to the contract in instances where the contract terms are modified.

### Exemplary Method for Management of Data for Health Care Devices Used in Medical Procedures

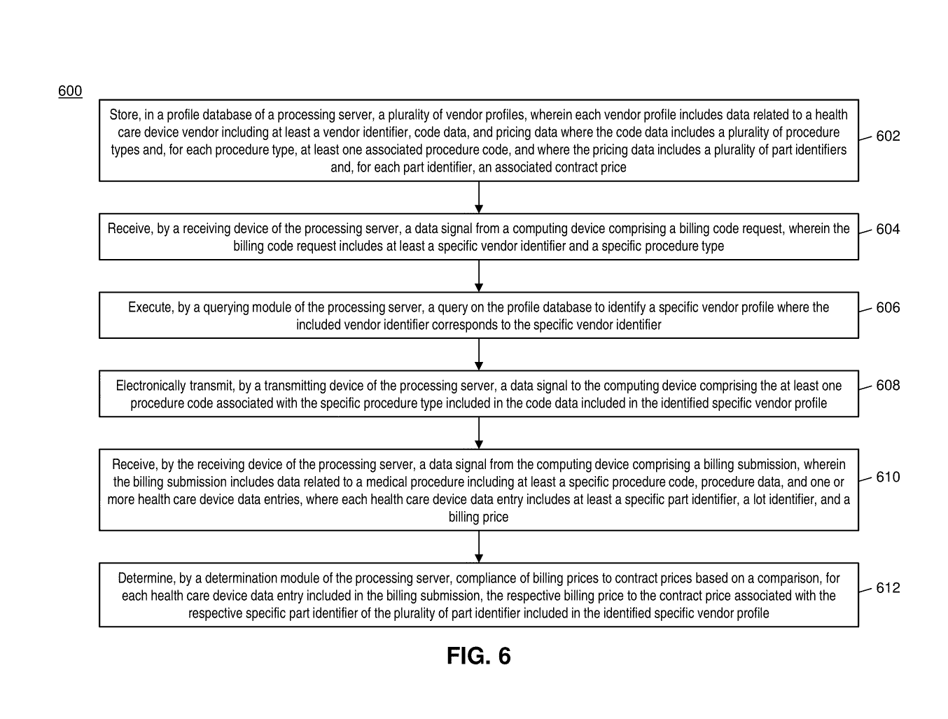

FIG. 6 illustrates a method 600 for the management of data for health care devices that includes the verification of prices billed for health care devices purchased for a specific medical procedure as compared to established contract prices.

In step 602, a plurality of vendor profiles (e.g., vendor profiles 208) may be stored in a profile database (e.g., the profile database 206) of a processing server (e.g., the processing server 102), wherein each vendor profile includes data related to a health care device vendor including at least a vendor identifier (e.g., vendor identifier 302), code data, and pricing data where the code data includes a plurality of procedure types (e.g., procedure types 304) and, for each procedure type, at least one associated procedure code (e.g., procedure codes 308), and where the pricing data includes a plurality of part identifiers (e.g., part identifiers 310) and, for each part identifier, an associated contract price (e.g., contract prices 312). In step 604, a data signal may be received by a receiving device (e.g., the receiving device 202) of the processing server from a computing device (e.g., the computing device 112) comprising a billing code request, wherein the billing code request includes at least a specific vendor identifier and a specific procedure type.

In step 606, a query may be executed by a querying module (e.g., the querying module 220) of the processing server on the profile database to identify a specific vendor profile where the included vendor identifier corresponds to the specific vendor identifier. In step 608, a data signal may be electronically transmitted by a transmitting device (e.g., the transmitting device 224) of the processing server to the computing device comprising the at least one procedure code associated with the specific procedure type included in the code data included in the identified specific vendor profile.

In step 610, a data signal comprising a billing submission may be received from the computing device by the receiving device of the processing server, wherein the billing submission includes data related to a medical procedure including at least a specific procedure code, procedure data, and one or more health care device data entries, where each health care device data entry includes at least a specific part identifier, a lot identifier, and a billing price. In step 612, a determination module (e.g., the identification module 218, notification module 222, etc.) of the processing server may determine compliance of billing prices to contract prices based on a comparison, for each health care device data entry included in the billing submission, the respective billing price to the contract price associated with the respective specific part identifier of the plurality of part identifier included in the identified specific vendor profile.

In one embodiment, the method 600 may further include storing, in a billing database (e.g., the billing database 214) of the processing server, a billing data entry (e.g., billing data entry 216), wherein the billing data entry includes data related to the billing submission including at least the specific procedure code, procedure data, and one or more health care device data entries, and further including, for each health care device data entry determined to be non-compliant, an indication of non-compliance. In some embodiments, the method 600 may also include electronically transmitting, by the transmitting device of the processing server, a data signal to a display device comprising at least the specific procedure code, procedure data, and one or more health care device data entries, and further including, for each health care device data entry determined to be non-compliant, an indication of non-compliance, wherein the display device is configured to parse the data signal for display of data comprised therein.

In one embodiment, the method 600 may further include electronically transmitting, by the transmitting device of the processing server, a data signal comprising an indication of non-compliance for each health care device data entry determined to be non-compliant. In a further embodiment, the data signal may comprise the indication of non-compliance is electronically transmitted to the computing device. In another further embodiment, each vendor profile may further include at least one notification e-mail address, and the data signal may comprise the indication of non-compliance is electronically transmitted to the at least one notification e-mail address included in the identified specific vendor profile.

In some embodiments, the code data in each vendor profile may further include a plurality of primary procedure types, and each procedure type of the plurality of procedure types may be associated with a primary procedure type of the plurality of primary procedure types. In a further embodiment, the method 600 may also include: receiving, by the receiving device of the processing server, a data signal from a computing device comprising a secondary type request, wherein the secondary type request includes at least a specific primary procedure type; and electronically transmitting, by the transmitting device of the processing server, a data signal to the computing device comprising each procedure type of the plurality of procedure types included in the identified specific vendor profile associated with the specific primary procedure type, wherein the specific procedure type is one of the procedure types of the plurality of procedure types associated with the specific primary procedure type included in the identified specific vendor profile.

In one embodiment, the procedure data may include at least one of: hospital name, hospital identifier, physician name, physician identifier, procedure time, procedure date, hospital data, physician data, and patient data. In some embodiments, the method 600 may also include: storing, in a notification database of the processing server, a plurality of notification rules, wherein each notification rule includes at least a data value and a notification e-mail address; executing, by the querying module of the processing server, a query on the notification database to identify at least one notification rule where the included data value corresponds to one of: the specific vendor identifier, the specific procedure code, the specific procedure type, the procedure data, a specific part identifier for one of the at least one health care data entry, a lot identifier for one of the at least one health care data entry, and a billing total based on a summation of the billing price for each of the at least one health care data entry; and electronically transmitting, by the transmitting device of the processing server, a data signal for each identified notification rule to the notification e-mail address include in the respective notification rule.

### Computer System Architecture

FIG. 7 illustrates a computer system 700 in which embodiments of the present disclosure, or portions thereof, may be implemented as computer-readable code. For example, the processing server 102 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4 and 6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 4 and 6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

The processor device 704 may comprise one or more modules or engines configured to perform the functions of the computer system 700. Each of the modules or engines may be implemented using hardware and, in some instances, may also utilize software, such as corresponding to program code and/or programs stored in the main memory 708 or secondary memory 710. In such instances, program code may be compiled by the processor device 704 (e.g., by a compiling module or engine) prior to execution by the hardware of the computer system 700. For example, the program code may be source code written in a programming language that is translated into a lower level language, such as assembly language or machine code, for execution by the processor device 704 and/or any additional hardware components of the computer system 700. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 700 to perform the functions disclosed herein. It will be apparent to persons having skill in the relevant art that such processes result in the computer system 700 being a specially configured computer system 700 uniquely programmed to perform the functions discussed above.

Techniques consistent with the present disclosure provide, among other features, systems and methods for management of data for health care devices used in medical procedures. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for the management of data for health care devices used in medical procedures, comprising:
storing, in a profile database of a processing server, a plurality of vendor profiles, wherein each vendor profile includes data related to a health care device vendor including at least a vendor identifier, code data, and pricing data where the code data includes a plurality of procedure types and, for each procedure type, at least one associated procedure code, and where the pricing data includes a plurality of part identifiers and, for each part identifier, an associated contract price;
receiving, by a receiving device of the processing server, a data signal from a computing device comprising a billing code request, wherein the billing code request includes at least a specific vendor identifier and a specific procedure type;
executing, by a querying module of the processing server, a query on the profile database to identify a specific vendor profile where the included vendor identifier corresponds to the specific vendor identifier;
electronically transmitting, by a transmitting device of the processing server, a data signal to the computing device comprising the at least one procedure code associated with the specific procedure type included in the code data included in the identified specific vendor profile;
receiving, by the receiving device of the processing server, a data signal from the computing device comprising a billing submission, wherein the billing submission includes data related to a medical procedure including at least a specific procedure code, procedure data, and one or more health care device data entries, where each health care device data entry includes at least a specific part identifier, a lot identifier, and a billing price; and
determining, by a determination module of the processing server, compliance of billing prices to contract prices based on a comparison, for each health care device data entry included in the billing submission, the respective billing price to the contract price associated with the respective specific part identifier of the plurality of part identifier included in the identified specific vendor profile.

2. The method of claim 1, further comprising:
storing, in a billing database of the processing server, a billing data entry, wherein the billing data entry includes data related to the billing submission including at least the specific procedure code, procedure data, and one or more health care device data entries, and further including, for each health care device data entry determined to be non-compliant, an indication of non-compliance.

3. The method of claim 1, further comprising:
electronically transmitting, by the transmitting device of the processing server, a data signal comprising an indication of non-compliance for each health care device data entry determined to be non-compliant.

4. The method of claim 3, wherein the data signal comprising the indication of non-compliance is electronically transmitted to the computing device.

5. The method of claim 3, wherein
each vendor profile further includes at least one notification e-mail address, and
the data signal comprising the indication of non-compliance is electronically transmitted to the at least one notification e-mail address included in the identified specific vendor profile.

6. The method of claim 1, further comprising:
electronically transmitting, by the transmitting device of the processing server, a data signal to a display device comprising at least the specific procedure code, procedure data, and one or more health care device data entries, and further including, for each health care device data entry determined to be non-compliant, an indication of non-compliance, wherein the display device is configured to parse the data signal for display of data comprised therein.

7. The method of claim 1, wherein
the code data in each vendor profile further includes a plurality of primary procedure types, and
each procedure type of the plurality of procedure types is associated with a primary procedure type of the plurality of primary procedure types.

8. The method of claim 7, further comprising:
receiving, by the receiving device of the processing server, a data signal from a computing device comprising a secondary type request, wherein the secondary type request includes at least a specific primary procedure type; and
electronically transmitting, by the transmitting device of the processing server, a data signal to the computing device comprising each procedure type of the plurality of procedure types included in the identified specific vendor profile associated with the specific primary procedure type, wherein
the specific procedure type is one of the procedure types of the plurality of procedure types associated with the specific primary procedure type included in the identified specific vendor profile.

9. The method of claim 1, wherein the procedure data includes at least one of: hospital name, hospital identifier, physician name, physician identifier, procedure time, procedure date, hospital data, physician data, and patient data.

10. The method of claim 1, further comprising:
storing, in a notification database of the processing server, a plurality of notification rules, wherein each notification rule includes at least a data value and a notification e-mail address;
executing, by the querying module of the processing server, a query on the notification database to identify at least one notification rule where the included data value corresponds to one of: the specific vendor identifier, the specific procedure code, the specific procedure type, the procedure data, a specific part identifier for one of the at least one health care data entry, a lot identifier for one of the at least one health care data entry, and a billing total based on a summation of the billing price for each of the at least one health care data entry; and
electronically transmitting, by the transmitting device of the processing server, a data signal for each identified notification rule to the notification e-mail address include in the respective notification rule.

11. A system for the management of data for health care devices used in medical procedures, comprising:
a determination module of a processing server;
a profile database of the processing server configured to store a plurality of vendor profiles, wherein each vendor profile includes data related to a health care device vendor including at least a vendor identifier, code data, and pricing data where the code data includes a plurality of procedure types and, for each procedure type, at least one associated procedure code, and where the pricing data includes a plurality of part identifiers and, for each part identifier, an associated contract price;
a receiving device of the processing server configured to receive a data signal from a computing device comprising a billing code request, wherein the billing code request includes at least a specific vendor identifier and a specific procedure type;
a querying module of the processing server configured to execute a query on the profile database to identify a specific vendor profile where the included vendor identifier corresponds to the specific vendor identifier; and
a transmitting device of the processing server configured to electronically transmit a data signal to the computing device comprising the at least one procedure code associated with the specific procedure type included in the code data included in the identified specific vendor profile, wherein
the receiving device of the processing server is further configured to receive a data signal from the computing device comprising a billing submission, wherein the billing submission includes data related to a medical procedure including at least a specific procedure code, procedure data, and one or more health care device data entries, where each health care device data entry includes at least a specific part identifier, a lot identifier, and a billing price, and
the determination module of the processing server is configured to compliance of billing prices to contract prices based on a comparison, for each health care device data entry included in the billing submission, the respective billing price to the contract price associated with the respective specific part identifier of the plurality of part identifier included in the identified specific vendor profile.

12. The system of claim 11, further comprising:
a billing database of the processing server configured to store a billing data entry, wherein the billing data entry includes data related to the billing submission including at least the specific procedure code, procedure data, and one or more health care device data entries, and further including, for each health care device data entry determined to be non-compliant, an indication of non-compliance.

13. The system of claim 11, wherein the transmitting device of the processing server is further configured to electronically transmit a data signal comprising an indication of non-compliance for each health care device data entry determined to be non-compliant.

14. The system of claim 13, wherein the data signal comprising the indication of non-compliance is electronically transmitted to the computing device.

15. The system of claim 13, wherein
each vendor profile further includes at least one notification e-mail address, and
the data signal comprising the indication of non-compliance is electronically transmitted to the at least one notification e-mail address included in the identified specific vendor profile.

16. The system of claim 11, wherein the transmitting device of the processing server is further configured to electronically transmit a data signal to a display device comprising at least the specific procedure code, procedure data, and one or more health care device data entries, and further including, for each health care device data entry determined to be non-compliant, an indication of non-compliance, wherein the display device is configured to parse the data signal for display of data comprised therein.

17. The system of claim 11, wherein
the code data in each vendor profile further includes a plurality of primary procedure types, and
each procedure type of the plurality of procedure types is associated with a primary procedure type of the plurality of primary procedure types.

18. The system of claim 17, wherein
the receiving device of the processing server is further configured to receive a data signal from a computing device comprising a secondary type request, wherein the secondary type request includes at least a specific primary procedure type,
the transmitting device of the processing server is further configured to electronically transmit a data signal to the computing device comprising each procedure type of the plurality of procedure types included in the identified specific vendor profile associated with the specific primary procedure type, and
the specific procedure type is one of the procedure types of the plurality of procedure types associated with the specific primary procedure type included in the identified specific vendor profile.

19. The system of claim 11, wherein the procedure data includes at least one of: hospital name, hospital identifier, physician name, physician identifier, procedure time, procedure date, hospital data, physician data, and patient data.

20. The system of claim 11, further comprising:
a notification database of the processing server configured to store a plurality of notification rules, wherein each notification rule includes at least a data value and a notification e-mail address, wherein
the querying module of the processing server is further configured to execute a query on the notification database to identify at least one notification rule where the included data value corresponds to one of: the specific vendor identifier, the specific procedure code, the specific procedure type, the procedure data, a specific part identifier for one of the at least one health care data entry, a lot identifier for one of the at least one health care data entry, and a billing total based on a summation of the billing price for each of the at least one health care data entry, and
the transmitting device of the processing server is further configured to electronically transmit a data signal for each identified notification rule to the notification e-mail address include in the respective notification rule.
